(19) United States
(12) Patent Application Publication
(10) Pub. No.: US 2012/0253641 A1
(43) Pub. Date: Oct. 4, 2012

(54) METHOD AND A CONTROL DEVICE FOR CONTROLLING AN ENGINE

(75) Inventors: Nick Warner, Cambridgeshire (GB); Trevor Fletcher, Leicestershire (GB)

(73) Assignee: T BADEN HARDSTAFF LTD, NOTTINGHAM (GB)

(21) Appl. No.: 13/256,125

(22) PCT Filed: Mar. 12, 2010
(86) PCT No.: PCT/GB2010/000458

§ 371 Date: Apr. 30, 2012

(30) Foreign Application Priority Data
Mar. 13, 2009 (GB) 09043571
Mar. 13, 2009 (GB) 09043720

(51) Int. Cl. F02D 19/08; F02D 41/30

(52) U.S. Cl. 701/104

(57) ABSTRACT

A method for controlling an engine in either a first mode in which the engine is fuelled by a first fuel, or in a second mode in which the engine is fuelled by a mixture of the first fuel and a second fuel, the method comprising the steps of programming the engine to operate initially in the first mode, repeatedly sensing a plurality of first variables and obtaining a measured value for each sensed first variable, and emitting a first input signal dependent on the measured value of each sensed first variable, causing a first output signal, comprising a plurality of injector control signals, to be emitted in dependence on the first input signals for controlling the amount of the first fuel supplied to the engine, switching the mode of operation to the second mode, selecting one or more of the injector control signals to produce a first modified signal, which determines the amount of first fuel supplied to the engine and generating a second calculated signal, which determines the amount of second fuel supplied to the engine.

This invention relates to a method and to a control device for controlling an engine and particularly, but not exclusively, to a method for controlling a dual fuel common rail diesel engine and to a control device for such an engine.

It is known to operate diesel engines on a mixture of diesel fuel and natural gas, so-called dual fuel operation.

A dual fuel diesel engine can provide a number of significant benefits to the vehicle operator. These include lower operating costs (since natural gas has historically been cheaper than diesel fuel), lower levels of exhaust emissions and increased operating range.

In a dual fuel engine it is necessary to reduce the amount of diesel fuel supplied to the engine while at the same time supplying the engine with a suitable quantity of natural gas to ensure that the overall power output of the engine remains substantially unaltered.

Diesel engines employ fuel injection pumps to supply and meter the diesel fuel to the engine cylinders.

Consequently, there are two basic techniques for reducing the amount of diesel fuel supplied to the engine; reducing the duration of the injection event and reducing the pressure at which the fuel is injected.

Since most diesel engines are now controlled electronically by an engine control unit (ECU) it has historically been easier to adopt the approach of reducing the duration of the injection event. This approach is simpler because the generation of diesel fuel pressure has conventionally been achieved by mechanical means and variation in fuel pressure has required additional hardware adding to the complexity of the system.

In recent years, engine manufacturers have adopted common rail technology for fuel injection in diesel engines in order to meet ever more stringent exhaust emissions regulations.

Common rail diesel injection systems operate at very much higher fuel pressures than distributor pump type systems, typically 1350 to 1750 bar. This increased fuel pressure in conjunction with developments in injector technology, such as piezo actuation and multi-hole nozzles, have enabled the engine manufacturers to achieve much closer control on the timing and quantities of fuel supplied to the engine.

This more precise metering of fuel to the engine has in turn enabled engines to meet the tightening exhaust emissions levels imposed by emissions regulations such as Euro III, Euro IV and Euro V.

In addition to being able to more precisely control the timing and quantity of an individual injection event, the developments in injector technology and in electronic control hardware have enabled the engine manufacturers to produce injection strategies comprising a sequence of multiple injection events.

For example, one commonly employed strategy is to use an initial pre-injection, followed by a main injection and then a final post-injection. This enables the delivery of the diesel fuel to be more precisely achieved through the individual engine cycle.

Multiple injection events allow for a more controlled combustion event with less particulate formation and a reduction in NOx emissions.

The use of multiple injection events has been adopted by many manufacturers of common rail engines and indeed has been extended to include common rail systems having more than three injection events per engine cycle.

A consequence of the use of common rail technology is that the fuel injection events are considerably shorter than was the case with engines equipped with older distributor pump technology.

When converting a common rail engine for dual fuel operation it is much more difficult to reduce the duration of the injection event since these individual injection events are already very short, for example of the order of μsec.

A problem associated with reducing the duration of these injection events is the need for greatly increased processing capacity in the second ECU in order to be able to intercept the injector signal, process the signal in real time, and generate and transmit a modified signal of shorter duration to the injector. This need for increased processing capacity greatly increases the cost and complexity of such a dual fuel conversion and may in some instances make such an approach impractical.

According to a first aspect of the present invention there is provided a method for controlling an engine in either a first mode in which the engine is fuelled by a first fuel, or in a second mode in which the engine is fuelled by a mixture of the first fuel and a second fuel, the method comprising the steps of:
programming the engine to operate initially in the first mode;
repeatedly sensing a plurality of first variables and obtaining a measured value for each sensed first variable, and emitting a first input signal dependent on the measured value of each sensed first variable;
causing a first output signal, comprising a plurality of injector control signals, to be emitted in dependence on the first input signals for controlling the amount of the first fuel supplied to the engine;
switching the mode of operation to the second mode;
selecting one or more of the injector control signals to produce a first modified signal, which determines the amount of first fuel supplied to the engine; and
generating a second calculated signal, which determines the amount of second fuel supplied to the engine.

An advantage of modifying the first output signal by selecting one or more of the injector control signals is that the method may be implemented using existing ECU technology. Since the technique involves only selecting one or more injector control signals and does not involve processing the signals in real-time, it does not require any significant increase in processing capacity.

A further advantage of the method is that it can readily be extended to applications in which the first output signal comprises three or more injector control signals. Indeed it is believed that the method is applicable to applications having any number of injector control signals.

Optionally, the step of selecting one or more of the injector control signals to produce a first modified signal, comprises the step of using a power switch to select one or more of the injector control signals.

In order to be able to precisely select one or more of the injector control signals it is necessary for the method of selection to be capable of operating at high signal frequencies.

This is achieved by means of the power switch which may take the form of MOSFET switch circuit, or other fast responding electronic power switch.

Optionally, the engine further comprises a pump for supplying the first fuel under pressure to injectors of the engine, and a pressure sensor which produces a second output signal indicative of the pressure of the first fuel supplied to the injectors by the pump, wherein the step of selecting one or more of the injector control signals to produce a first modified signal, comprises the steps of:
modifying the second output signal from the fuel pressure sensor;
producing a variation in the pressure of the first fuel supplied to the injectors;
calculating a variance in the amount of the first fuel supplied to the injectors as a result of the variation in pressure;
selecting one or more of the injector control signals from the first output signal to produce the first modified signal;
the first modified signal, in conjunction with the first fuel variance, determining the amount of first fuel supplied to the engine and the second calculated signal determining the amount of second fuel supplied to the engine.

Optionally, the method comprises the additional steps of controlling the timing of flow of the first fuel into the engine when the engine is the first mode, in dependence on the first input signals, and controlling the timing of flow of both the first fuel and the second fuel into the engine when the engine is running in the second mode in dependence on the first modified signal and the second calculated signal, respectively.

Optionally, the method comprises the further steps of:
calculating the calorific content of a first amount of first fuel that would be supplied to the engine if the engine were running in the first mode;
calculating the calorific content of a second amount of first fuel supplied to the engine when the engine is running in the second mode;
comparing the calorific content of the first amount of first fuel and the calorific content of the second amount of first fuel to calculate an energy deficit; and
calculating a required amount of second fuel to be supplied to the engine when the engine is running a second mode in order to compensate for the energy deficit.

Optionally, the method comprises the further step of:
returning a signal to the first ECU in an unmodified form corresponding to each of the first input signals.

According to a second aspect of the present invention there is provided a method for controlling an engine, the method comprising the steps of:
repeatedly sensing a plurality of first variables and obtaining a measured value for each sensed first variable, and emitting a first input signal dependent on the measured value of each sensed first variable;
causing a first output signal to be emitted in dependence on the first input signals for controlling the amount of a first fuel supplied to the engine;
a fuel pressure sensor sensing a pressure of the first fuel supplied to injectors of the engine by a pump, and emitting a second output signal dependent on the pressure of the first fuel; and
an engine control unit modifying the second output signal to vary the pressure of the first fuel supplied to the injectors.

According to a third aspect of the present invention there is provided a control device for an engine adapted to operate in a plurality of different modes including a first mode in which the engine is fuelled substantially entirely by a first fuel, and a second mode in which the engine is fuelled by a mixture of the first fuel and a second fuel, the control device comprising:

a first engine control unit (ECU) being adapted to emit a first output signal for determining the flow of first fuel into the engine when the engine is operating in the first mode, the first output signal comprising a plurality of injector control signals; and
a second ECU operatively connected to the first ECU and being adapted to intercept the first output signal;

the second ECU being further adapted to select one or more of the injector control signals, when the engine is running in the second mode, to produce a first modified signal and a second calculated signal, the first modified signal determining the amount of first fuel supplied to the engine, and the second calculated signal determining the amount of second fuel supplied to the engine.

Optionally, the second ECU further comprises a power switch operable to select one or more of the plurality of injector control signals.

Optionally, the engine further comprises a pump for supplying the first fuel under pressure to injectors of the engine, and a pressure sensor which produces a second output signal indicative of the pressure of the first fuel supplied to the injectors by the pump;
the first ECU being adapted to control the pump, when the engine is running in the first mode, to vary the pressure of the first fuel supplied to the injectors in a pre-programmed manner in response to the second output signal;
the second ECU being adapted to modify the second output signal, when the engine is running in the second mode, such that the second ECU operates the pump to produce a variation in the pressure of the first fuel supplied to the injectors in accordance with the modified second output signal, the variation in pressure, the variation in fuel pressure over the duration of the first modified signal being associated with a variance in the amount of the first fuel supplied to the engine;
the first modified signal in conjunction with the first fuel variance determining the amount of the first fuel supplied to the engine, and the second calculated signal determining the amount of the second fuel supplied to the engine.

Optionally, the control device further comprises a calculator for calculating the calorific content of a first amount of first fuel that would be supplied to the engine if the engine were running in the first mode, and the calorific content of a second amount of first fuel supplied to the engine when the engine is running in the second mode, a comparator for comparing the difference between the calorific content of the first amount of first fuel and the calorific content of the second amount of first fuel, the calculator being further adapted to calculate a required amount of second fuel to be supplied to the engine when the engine is running in the second mode in order to ensure that the overall calorific content of the second amount of first fuel and the amount of second fuel is substantially the same as the calorific content of the first amount of first fuel.

Optionally, the second ECU further comprises a signal returner for returning the first output signals to the first ECU in an unmodified form when the engine is running in either the first mode or the second mode.

According to a fourth aspect of the present invention there is provided a control device for an engine, the engine including a pump for supplying a first fuel under pressure to injectors of the engine, a pressure sensor which produces a second output signal indicative of the pressure of the first fuel supplied to the injectors by the pump, and an engine control unit (ECU) adapted to control the pump to vary the pressure of the first fuel supplied to the injectors in a pre-programmed manner in response to the second output signal;
the control device being adapted for connection to the ECU and the pressure sensor, and being adapted to modify the second output signal such that the ECU operates the pump to vary the pressure of the first fuel supplied to the injectors in accordance with the modified second output signal.

Optionally, the second ECU includes a modification circuit electrically connected to the pressure sensor in order to receive the second output signals therefrom, and adapted to create a modified second output signal to vary the pressure of the first fuel supplied to the injectors.

There now follows a description of preferred embodiments of the invention, by way of non-limiting example, with reference being made to accompanying drawings in which:

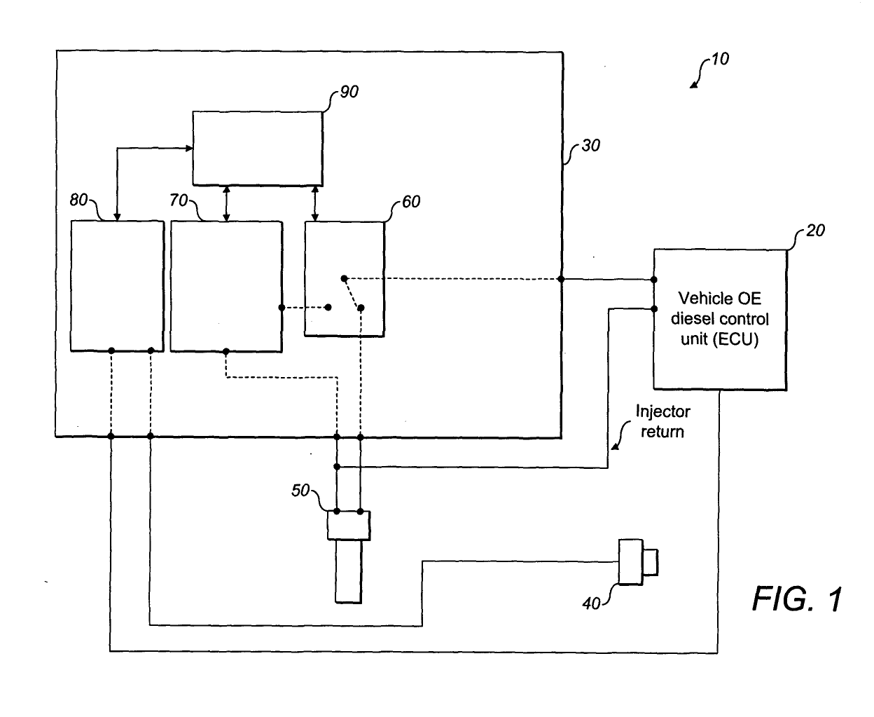

FIG. 1 is a schematic representation of a control device for a dual fuel common rail diesel engine according to a first embodiment of the invention, showing the power switch set to the normal position;

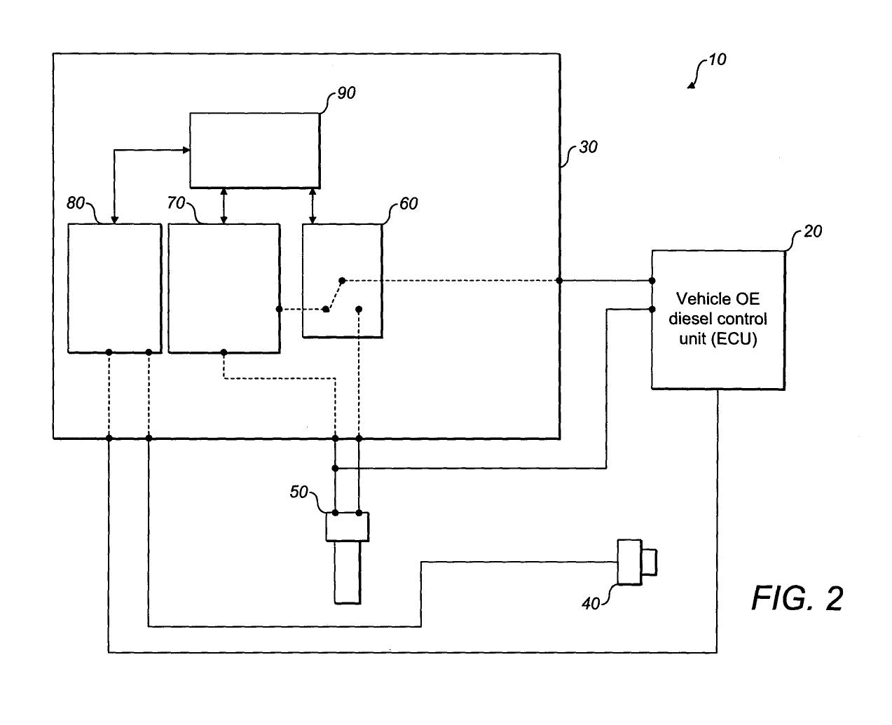

FIG. 2 is a schematic representation of the control device of FIG. 1, showing the power switch set to the emulation position;

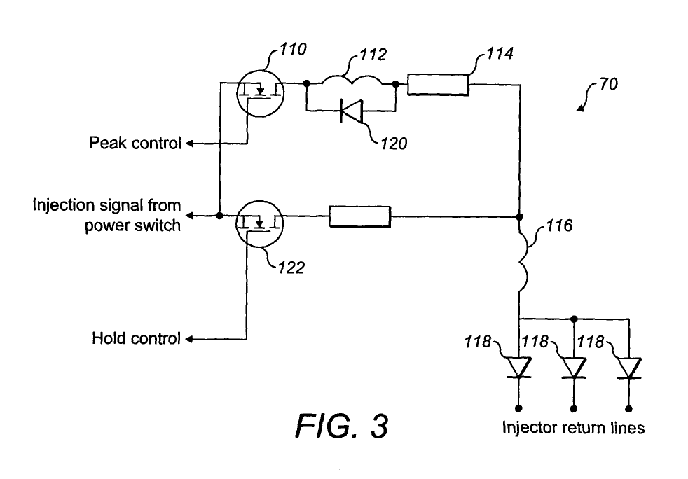

FIG. 3 is a circuit diagram of the injector emulator system of the control device of FIG. 1;

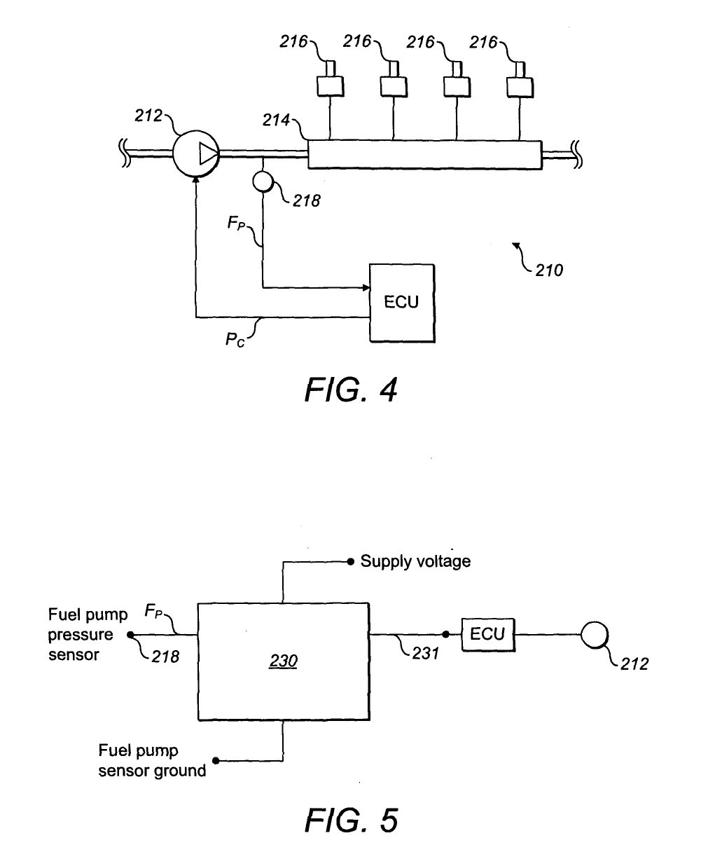

FIG. 4 is a schematic representation of a high pressure common rail fuel injection system according to a second embodiment of the invention;

FIG. 5 is a schematic representation illustrating one way of incorporating a control device of the present invention into the system represented in FIG. 4;

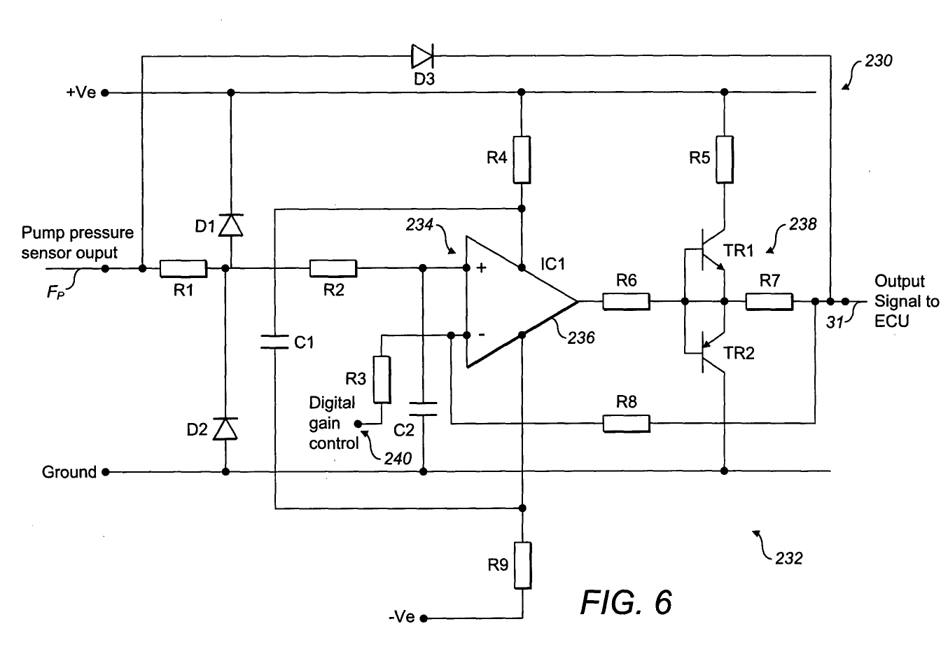

FIG. 6 is a circuit diagram of a control device according to the second embodiment of the invention; and

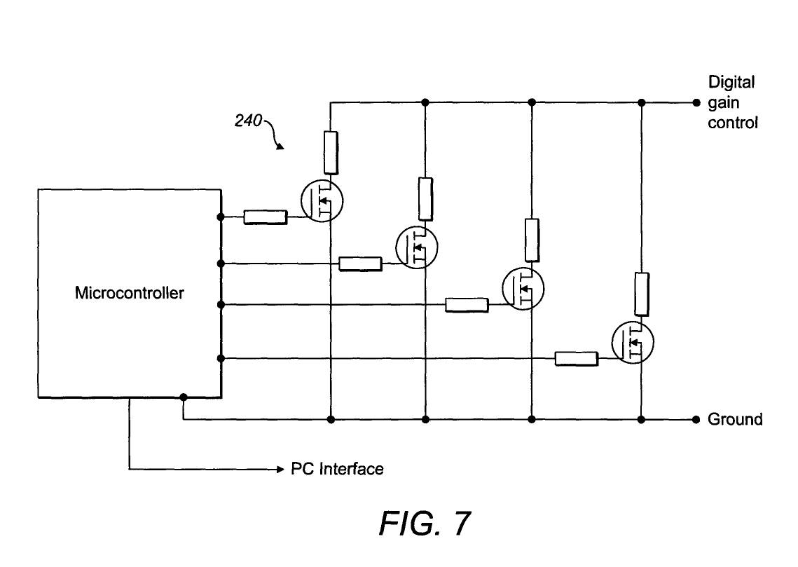

FIG. 7 is a circuit diagram of a digital gain control used in the circuit of FIG. 6.

Referring to FIGS. 1 and 2, a control device according to a first embodiment of the invention is designated generally by the reference numeral 10. The control device 10 comprises a first engine control unit (ECU) 20 and a second ECU 30.

In the embodiment shown, the control device 10 is installed on a six cylinder diesel engine (not shown) of a typical commercial vehicle. The diesel engine includes an electronically controlled, engine driven, high pressure fuel pump (not shown), a fuel pressure sensor 40, and a diesel fuel injector 50 per cylinder. The diesel fuel injectors 50 are supplied with diesel fuel by a common accumulator fuel rail containing the fuel at a pressure of approximately 1,350 bar.

The first ECU 20 the controls the quantity and timing of the diesel fuel supplied to the engine in order to provide the required power and torque outputs, when the engine is operating in a diesel only mode.

In the present embodiment, the injection strategy of the first ECU 20 includes three injection events; a pre-injection, a main and a post-injection event.

The second ECU 30 is electrically connected to the first ECU 20, and intercepts the injector drive signals sent from the first ECU 20 to the engine's injectors 50.

When the engine is operating in a diesel only mode, the injector drive signals generated by the first ECU 20 are relayed via the second ECU 30 to the engine's injectors and the engine operates in the same manner as a standard diesel engine.

The engine may also be operated in this mode at low levels of gas substitution or if the dual fuel operation is to be disabled.

In addition, if the electrical power to the second ECU 30 is removed for any reason, the system defaults to this diesel only mode of operation.

The second ECU 30 controls the supply of natural gas to the engine in conjunction with reducing the quantity of diesel supplied to the engine, when the engine is operating in a dual fuel mode.

The second ECU 30 includes a power switch 60, an injector emulator system 70 and a fuel pressure reduction system 80, each of which are controlled by a microcontroller 90.

The number of power switches 60 and injector emulators 70 in a system will depend upon the engine configuration. The present embodiment includes two emulators 70 and two power switches 60 with each emulator and power switch handling three diesel injectors 50.

The fuel pressure sensor 40 which senses the pressure of the fuel in the common rail, is connected to the second ECU 30. The first ECU 20 receives a fuel pressure signal from the second ECU 30.

When the engine is operating in a diesel only mode, the second ECU 30 relays the fuel pressure signal in an unmodified form to the first ECU 20.

However, when the engine is operating in a dual fuel mode the second ECU 30 modifies the fuel pressure signal before relaying the modified signal to the first ECU 20. The effect of this modification is to deceive the first ECU 20 by making the fuel pressure appear to be excessively high. Consequently, the first ECU 20 electronically controls the fuel pump to reduce the fuel pressure in the common rail.

The power switch 60 receives the injector drive signals generated by the first ECU 20 and is configured to either relay the signals directly to the engine's injectors 50 or to route the signals to the injector emulator system 70.

If the injector drive signal is routed to the injector 50, as shown in FIG. 1, the first ECU 20 sends an injector control signal to the injector 50 which then injects the corresponding quantity of diesel fuel into the engine. The injector 50 then returns a signal to the first ECU 20 confirming that the injection event has been completed correctly.

When the injector drive signal is routed to the injector emulator system 70, as shown in FIG. 2, the injector does not operate and no diesel fuel is delivered to the engine.

However the injector emulator system 70 generates an electrical waveform which represents the confirmatory signal which the diesel injector 50 would normally have transmitted back to the first ECU 20. This will allow the first ECU 20 to believe that the diesel injector 50 has been supplied with the drive signal, and is working correctly.

When the engine is operating in a dual fuel mode, the operation of the power switch 60 is controlled by the microcontroller 90 in response to the engine crankshaft position and the level of gas substitution being implemented.

The power switch 60 is normally set to route the injector drive signal to the respective injector 50. The power switch 60 remains in this position until the pre-injection and main injection events have occurred and a position in the engine cycle has been reached where a post-injection event can be expected. At this point, the power switch 60 is changed to route the injector drive signal to the injector emulation system 70.

The injection signal is then passed to the injector emulation system 70 instead of the diesel fuel injector 50 and no diesel fuel is injected into the engine.

The respective engine cylinder will still fire, because the cylinder contains sufficient natural gas to make up for the loss of diesel fuel associated with the post-injection event together with the reduced amount of diesel supplied from the pre-injection and main injection events due to reduced diesel pressure.

Once the post-injection event signal has been received by the injector emulator system 70, the power switch 60 is returned to its initial position to route the injector drive signals from the next pre-injection and main injection events to the respective diesel injector 50.

FIG. 3 shows a schematic arrangement of the injector emulator system 70 which is intended to generate an electrical waveform that replicates the signal seen by the first ECU 20 when the diesel injector operates normally.

The injector emulator system 70 comprises a peak control portion, a hold control portion and diodes 118.

The peak control portion comprises a peak switch 110, a first inductor 112, a peak resistor 114, a second inductor 116 and a catch diode 120. The hold portion comprises a hold switch 122.

At the start of an injection event, the peak switch 110 is switched on by applying an electrical signal is applied to its input. Current then flows through the peak switch 110, the first inductor 112, the peak resistor 114, the second inductor 116 and back to the first ECU 20 via an injector return line through a diode 118. The rate at which current build-up occurs is dictated by a combination of the injection system voltage, the value of the peak resistor 114 and combined values of inductors 112, 116. In the present embodiment, the values of the resistor 114 and inductors 112, 116 are chosen to allow the current to peak at approximately 26 A after 100 uS with a system voltage of 50V.

Between the individual injection events, a signal is applied to the input to the hold switch 122 in order to block the flow of current through the peak switch 110. The current flowing in the peak inductor 112 will now slowly reduce to zero through the catch diode 120.

Applying a signal to the hold switch 122 therefore allows current to build up and fall more rapidly through the injector emulator circuit 70. The difference between the build up of current using a peak control input and the fall in current using the hold control allows the current to more closely represent the behaviour of the current as it would when an injector 50 operates.

Most importantly, the flow of current through these two parts of the injector emulator circuit 70 is continuous, thus representing the change in characteristic that is representative of an actual injector.

Referring to FIG. 4 a fuel injection system according to a second embodiment of the invention is designated generally by the reference numeral 210.

The fuel injection system 210 includes a high pressure pump 212 which supplies high pressure fuel to a common rail 214. A plurality of fuel injectors 216 communicate with the common rail 214 and inject fuel into respective cylinders (not shown) under the control of the engine control unit ECU (the control wiring between the ECU and injectors 216 is omitted for the sake of clarity).

The ECU controls operation of the high pressure pump 212 (by sending control output signals along wire Pc) to vary the fluid pressure with in the rail 214 in response to the operating conditions of the engine. In this respect, the ECU includes a microprocessor which has a memory in which the required working fluid pressures for given engine operating conditions are stored.

A pressure sensor 218 is provided which senses the fluid pressure in the rail 214 and provides an output signal along wire Fp to the ECU indicative of the sensed pressure. The ECU reacts to the sensed pressure to vary operation of the pump 212 to create the desired, pre-programmed, pressure in the rail 214.

In accordance with the present invention there is provided a control device 230 (see FIGS. 5 and 6) which acts to modify the pressure output signal in a predetermined manner so that the ECU acts to control the pump 212 to provide a fluid pressure which is different to that which the ECU is pre-programmed to provide.

As seen in FIG. 5 the control device 230 is inserted inbetween the sensor 218 and ECU, i.e. the wire Fp is disconnected from the ECU and instead connected as an input to the device 230. An output wire 231 is then connected to the ECU such that the ECU then receives control output signals indicative of ‘modified’ fluid pressure as determined by the control device 230.

The device 230 operates in response to the sensed pressure output signal from sensor 18 to modify that signal and create a modified output signal for output to the ECU which is indicative of a higher fluid pressure than the actual fluid pressure in the rail 214. This causes the ECU to control the pump to reduce the fluid pressure in the rail 214. Although this reduction in pressure will cause a reduction in power performance of the engine it can instead result in an improvement in fuel consumption. The degree by which the pressure signal is modified is determined by experimentation to achieve optimal desired results.

An example of a suitable control device is illustrated in FIGS. 6 and 7.

In essence, the device 230 serves to reduce the diesel pump fuel pressure by forcing less contribution to the signal seen by the ECU from the pressure sensor 218. This is achieved using a modification circuit 232 which includes an amplifier 234, in the form of operational amplifier IC1 236 and output buffer 238, and a gain control 240 controlled by a microprocessor.

The modification circuit 232 shown in FIG. 6 is centred around an operational amplifier IC1 236. Resistors R4 and R9 serve two purposes, the first to provide a low pass filter with C1 to attenuate power supply noise, the second to limit the current should a fault occur within the circuit. Resistor R1 acts with D1 and D2 to limit any conducted voltage transients that may appear on the pump sensor input. This way, the junction at R1, D1, D2 will be limited to 0.5V above +ve, and 0.5V below ground to protect IC1. R2 and C2 act as low pass filter to average the voltage presented at the non-inverting (+) input of IC1 236.

Transistors TR1 and TR2 provide a buffer to the ECU input from IC1 236, together with R5 and R7. R5 serves two purposes, the first to reduce power dissipation in TR1, the second to limit the current.

Diode D3 is placed so as to define a bypass circuit which is able to act as a backup mechanism. Should the modification circuit 232 cease to function correctly, then the actual pressure sensor voltage signal will be presented to the ECU. Under normal conditions, the voltage at the output would be higher than the input, and therefore diode D3 would be reverse biased preventing any direct current flow into the ECU from the pressure sensor.

R8 and R3 form a feedback circuit in conjunction with a digital gain control circuit shown in FIG. 7. IC1 236 will try to match the voltage at the pressure sensor input with the voltage presented to the ECU at the output. The feedback circuit does this by increasing/decreasing the current into R6, and then comparing the voltage at the inverting (−) input through R8 with that at the non-inverting input (+). By setting the gain resistance using the digital gain control circuit of FIG. 7, the output will always be higher at the output of the ECU than at the pressure input by:

V_{out to ECU}=V_{pressure sensor}×(1+R8/(R3+R8+R_{digital gain circuit}))

In response to this, the ECU will alter the PWM at the pump solenoids to correct the voltage presented at the ECU input reducing the pressure. The reduction in pressure reduces the voltage output of the pressure sensor 218, correcting the signal presented to the ECU by the device 230 and satisfying the ECU pump pressure control loop.

The embodiment shown incorporates a digital gain control 240, so that the amount of pressure reduction could be adjusted to suit the vehicle under test. The digital gain control 240 could be set using a PC connected via a communication interface.

In FIG. 7 the gain to the amplifier IC1 is controlled using eight MOSFET transistors (four shown), each connected via a resistor to the digital gain control. The eight resistors form a ladder, each double the value of the next so as to give 256 steps. Each step is made by turning on the MOSFET transistors in order, where 0 gain is all MOSFET transistors OFF, and maximum gain is the 256^{th} step with all MOSFET transistors ON.

In the instance of 0 gain where all MOSFET transistors are turned OFF, the output signal presented to the ECU will equal the pump pressure signal and full engine power will be restored.

A digital gain control 240 including a microcontroller with PC interface control, i.e. a communication interface, has been implemented for ease of configuration but could be replaced with an analogue circuit that is either be preset by fixed resistor value, or variable as this design, or some variation of both.

In summary, the method and control device of the present invention enable a diesel engine equipped with a common rail fuel injection system to be readily converted to operate in a dual fuel mode using readily available ECU hardware.

This enables a vehicle operator to take advantage of the efficient operation of a common rail equipped diesel engine while further benefiting from the advantages of dual fuel engine operation.

1. A method for controlling an engine in either a first mode in which the engine is fuelled by a first fuel, or in a second mode in which the engine is fuelled by a mixture of the first fuel and a second fuel, the method comprising the steps of:
programming the engine to operate initially in the first mode;
repeatedly sensing a plurality of first variables and obtaining a measured value for each sensed first variable, and emitting a first input signal dependent on the measured value of each sensed first variable;
causing a first output signal, comprising a plurality of injector control signals, to be emitted in dependence on the first input signals for controlling the amount of the first fuel supplied to the engine;
switching the mode of operation to the second mode;
selecting one or more of the injector control signals to produce a first modified signal, which determines the amount of first fuel supplied to the engine; and
generating a second calculated signal, which determines the amount of second fuel supplied to the engine.

2. A method for controlling an engine according to claim 1, wherein the step of selecting one or more of the injector control signals to produce a first modified signal, comprises the step of:
using a power switch to select one or more of the injector control signals.

3. A method for controlling an engine according to claim 1, the engine further comprising a pump for supplying the first fuel under pressure to injectors of the engine, and a pressure sensor which produces a second output signal indicative of the pressure of the first fuel supplied to the injectors by the pump, wherein the step of selecting one or more of the injector control signals to produce a first modified signal, comprises the steps of:
modifying the second output signal from the fuel pressure sensor;
producing a variation in the pressure of the first fuel supplied to the injectors;
calculating a variance in the amount of the first fuel supplied to the injectors as a result of the variation in pressure;
selecting one or more of the injector control signals from the first output signal to produce the first modified signal;
the first modified signal, in conjunction with the first fuel variance, determining the amount of first fuel supplied to the engine and the second calculated signal determining the amount of second fuel supplied to the engine.

4. A method for controlling an engine according to claim 1, the method comprising the additional steps of controlling the timing of flow of the first fuel into the engine when the engine is the first mode, in dependence on the first input signals, and controlling the timing of flow of both the first fuel and the second fuel into the engine when the engine is running in the second mode in dependence on the first modified signal and the second calculated signal, respectively.

5. A method for controlling an engine according to claim 1, the method comprising the further steps of:
calculating the calorific content of a first amount of first fuel that would be supplied to the engine if the engine were running in the first mode;
calculating the calorific content of a second amount of first fuel supplied to the engine when the engine is running in the second mode;
comparing the calorific content of the first amount of first fuel and the calorific content of the second amount of first fuel to calculate an energy deficit; and
calculating a required amount of second fuel to be supplied to the engine when the engine is running a second mode in order to compensate for the energy deficit.

6. A method for controlling an engine according to claim 1, the method comprises the further step of:
returning a signal to the first ECU in an unmodified form corresponding to each of the first input signals.

7. A method for controlling an engine, the method comprising the steps of:
repeatedly sensing a plurality of first variables and obtaining a measured value for each sensed first variable, and emitting a first input signal dependent on the measured value of each sensed first variable;
causing a first output signal to be emitted in dependence on the first input signals for controlling the amount of a first fuel supplied to the engine;
a fuel pressure sensor sensing a pressure of the first fuel supplied to injectors of the engine by a pump, and emitting a second output signal dependent on the pressure of the first fuel; and
an engine control unit modifying the second output signal to vary the pressure of the first fuel supplied to the injectors.

8. A control device for an engine adapted to operate in a plurality of different modes including a first mode in which the engine is fuelled substantially entirely by a first fuel, and a second mode in which the engine is fuelled by a mixture of the first fuel and a second fuel, the control device comprising:
a first engine control unit (ECU) being adapted to emit a first output signal for determining the flow of first fuel into the engine when the engine is operating in the first mode, the first output signal comprising a plurality of injector control signals; and
a second ECU operatively connected to the first ECU and being adapted to intercept the first output signal;
the second ECU being further adapted to select one or more of the injector control signals, when the engine is running in the second mode, to produce a first modified signal and a second calculated signal, the first modified signal determining the amount of first fuel supplied to the engine, and the second calculated signal determining the amount of second fuel supplied to the engine.

9. The control device according to claim 8, wherein the second ECU further comprises a power switch operable to select one or more of the plurality of injector control signals.

10. The control device according to claim 8, wherein the engine further comprises a pump for supplying the first fuel under pressure to injectors of the engine, and a pressure sensor which produces a second output signal indicative of the pressure of the first fuel supplied to the injectors by the pump;
the first ECU being adapted to control the pump, when the engine is running in the first mode, to vary the pressure of the first fuel supplied to the injectors in a pre-programmed manner in response to the second output signal;
the second ECU being adapted to modify the second output signal, when the engine is running in the second mode, such that the second ECU operates the pump to produce a variation in the pressure of the first fuel supplied to the injectors in accordance with the modified second output signal, the variation in pressure, the variation in fuel pressure over the duration of the first modified signal being associated with a variance in the amount of the first fuel supplied to the engine;
the first modified signal in conjunction with the first fuel variance determining the amount of the first fuel supplied to the engine, and the second calculated signal determining the amount of the second fuel supplied to the engine.

11. A control device for an engine according to claim 8, further comprising a calculator for calculating the calorific content of a first amount of first fuel that would be supplied to the engine if the engine were running in the first mode, and the calorific content of a second amount of first fuel supplied to the engine when the engine is running in the second mode, a comparator for comparing the difference between the calorific content of the first amount of first fuel and the calorific content of the second amount of first fuel, the calculator being further adapted to calculate a required amount of second fuel to be supplied to the engine when the engine is running in the second mode in order to ensure that the overall calorific content of the second amount of first fuel and the amount of second fuel is substantially the same as the calorific content of the first amount of first fuel.

12. The control device according to claim 8, wherein the second ECU further comprises a signal returner for returning the first output signals to the first ECU in an unmodified form when the engine is running in either the first mode or the second mode.

13. A control device for an engine, the engine including a pump for supplying a first fuel under pressure to injectors of the engine, a pressure sensor which produces a second output signal indicative of the pressure of the first fuel supplied to the injectors by the pump, and an engine control unit (ECU) adapted to control the pump to vary the pressure of the first fuel supplied to the injectors in a pre-programmed manner in response to the second output signal;
the control device being adapted for connection to the ECU and the pressure sensor, and being adapted to modify the second output signal such that the ECU operates the pump to vary the pressure of the first fuel supplied to the injectors in accordance with the modified second output signal.

14. The control device according to claim 10, wherein the second ECU includes a modification circuit electrically connected to the pressure sensor in order to receive the second output signals therefrom, and adapted to create a modified second output signal to vary the pressure of the first fuel supplied to the injectors.

15. An engine including a control device according to claim 9.
